(19) United States
(12) Patent Application Publication
(10) Pub. No.: US 2008/0304462 A1
(43) Pub. Date: Dec. 11, 2008

(54) SESSION INITIATION PROTOCOL/INTERNET PROTOCOL MULTIMEDIA SUBSYSTEM BASED ARCHITECTURE FOR SUPPORTING 3G1x VOICE/DATA

(75) Inventors: John Kenney Burgess, Morristown, NJ (US); Andrew C. Clark, Succasunna, NJ (US); James Ray Freeburg, Naperville, IL (US); Hoo Dennis Ong, Westerville, OH (US); Maria E. Palamara, Denville, NJ (US); K. Jeffrey Rabourn, Aurora, IL (US); Robin Jeffrey Thompson, Batavia, IL (US); Alex Lawrence Wierzbicki, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: LUCENT TECHNOLOGIES, INC., Murray Hill, NJ (US)

(21) Appl. No.: 11/758,555

(22) Filed: Jun. 5, 2007

(51) Int. Cl. H04B 7/216

(52) U.S. Cl. 370/342

(57) ABSTRACT

A core network architecture for supporting an internet protocol based network is disclosed. The system includes a base station which is configured to convert a signal from a first network to an internet protocol network signal and send the converted signal through the internet protocol base network. The network also includes a gateway which is configured to receive the converted signal and deploy the converted signal through the internet protocol base network. In this sense, the internet protocol base network manages the call mobility and delivery of the signal. The base station in this disclosure may be a femto base station and the first network may be a code division multi-access (CDMA) network.

### CROSS REFERENCE TO RELATED PATENTS AND APPLICATIONS

This application is related to U.S. application Ser. No. ______, filed Jun. 1, 2007, entitled “METHOD TO ALLOW HAND-OFF OF A CDMA MOBILE FROM IMS FEMTOCELL TO CIRCUIT MSC, Inventor Thompson, Attorney Docket No. Thompson 27/LUTZ 2 00528, and U.S. application Ser. No. ______, filed Jun. 1, 2007, entitled “METHOD AND APPARATUS TO ALLOW HAND-OFF FROM A MACROCELL TO A FEMTOCELL, Inventor Burgess and Thompson, Attorney Docket No. Burgess 14-25/LUTZ 2 00526. These applications are hereby incorporated by reference.

### BACKGROUND OF THE DISCLOSURE

This disclosure relates to an apparatus and method for supporting and converting a signal in one network to another. More particularly, this disclosure relates to a method and apparatus for converting a signal in a first network, i.e. Code Divisional Multi-access (CDMA) network to an Internet protocol Multimedia Subsystem (IMS) network.

While the disclosure is particularly directed to telecommunications architecture and will thus be described with specific reference thereto, it will be appreciated that the disclosure may have usefulness in other fields and applications. For example, this disclosure may be used in variety of data transfer systems in order to support the gradual migration of one network entity to another thereby allowing service providers to invest their energy in future IMS technology.

By way of background, CDMA mobiles are in use all over the world. Many people use these handsets in order to transfer voice and data through a well established radio network. Currently, there are many methods for configuring voice path handoffs across the CDMA radio network.

The IMS/Session Initiation Protocol (SIP) based network is an internet based network that supports many other types of handsets. These handsets use Voice over Internet Protocol (VoIP) and other methods to transfer data voice and real time applications across Internet Protocol (IP) network. Although the IMS network is less commonly used in order to transfer voice and data, it is gaining popularity over other networks.

Currently in the industry there is no effective way to convert a signal from one network to an IMS network. The current systems in place only allow IP signals to be covered on the IP network. There is a need in the industry to allow IMS network coverage and capacity to be extended to signals originally made to be transferred over other networks. There is a further need for these signals to be converted and received on an IMS network and managed though seamless means. There is also a need for an architecture which will allow handoffs from the IMS network to the networks and from these other networks to IMS networks.

Furthermore, data is a large component of third generation wireless systems. However, much of the third generation wireless architecture is only optimized for voice and not for data. This causes problems with latency and data performance. Therefore, there is a need in the industry to supply a data network and allow for IP awareness to take place on the CDMA network.

The present invention contemplates a new and improved architecture that resolves the above-referenced difficulties and others.

### SUMMARY OF THE INVENTION

An apparatus for core network architecture that enables and supports gradual migration to and from internet protocol based network is provided. The disclosure will allow for the conversion of a call that originated in a first network to be carried and processed to an internet protocol based network without changing or manipulating the mobile unit or the current network architecture in place.

In one aspect of the disclosure the system includes a core network architecture for supporting seamless migration to and from an internet protocol based network. The core network architecture comprises a base station configured to convert a signal from a first network signal to an internet protocol network signal and send the converted signal via the internet protocol based network and a network gateway configured to receive the converted signal and deploy the converted signal through the internet protocol based network which manages the call mobility and delivery of the signal.

In accordance with another aspect of the present disclosure, the system includes a femtocell base station as the base station.

In accordance with another aspect of the present disclosure, the system includes that the first network is CDMA network.

In accordance with yet another aspect of the present disclosure, the system further includes an operations administration and management server configured to initialize relevant data associated with the converted signal.

In another aspect of the present disclosure the system includes that the relevant data comprises power settings, a Pseudo random Number (PN) offset information and a neighborhood list.

In accordance with another aspect of the present disclosure, the system includes a feature server which is configured to provide supplemental services associated with the converted signal. The supplemental services may include call waiting, caller ID, three way calling, etc.

In accordance with yet another aspect of the present disclosure, the system further includes a mobile switching center emulator which is configured to facilitate with authenticating the mobile unit.

In accordance with another aspect of the present disclosure, a method includes converting a call from a first network to an internet protocol based network. The method comprises establishing a call on the first network that is within the service range of a base station, converting the call from the first network to an internet protocol based network via the base station and forwarding the converted call through the internet protocol based network.

In accordance with yet another aspect of the present disclosure, the method includes the first network being a CDMA network.

In accordance with another aspect of the present disclosure, the method includes that the call is first established on a CDMA mobile station.

In accordance with another aspect of the present disclosure, the method would include that the base station be a femto base station.

In accordance with yet another aspect of the present disclosure, the method would include autoconfiguring data associated with the call.

In accordance with another aspect of the present disclosure, the method includes maintaining the call while the call is converted from the first network to the internet protocol based network.

In accordance with yet another aspect of the present disclosure, the system for supporting voice and data in a wireless radio broadband data standard in an associated internet protocol multimedia system comprising a base station configured to translate a call that originates from a CDMA system into SIP messaging, handoff application server configured to facilitate handoff procedures for the call, a feature server configured to provide service features for the call and a network gateway that provides security between the base station and an associated core network and forwards the call through the associated internet protocol media system.

In accordance with yet another aspect of the present disclosure, the system includes that the call be originated in a CDMA network.

In accordance with another aspect of the present disclosure, the system includes that the call was placed from a CDMA mobile.

In accordance with yet another aspect of the present disclosure, the system further includes that the base station be a femto base station router.

In accordance with yet another aspect of the present disclosure, the system includes a mobility application server which provides call management services for the call.

### DESCRIPTION OF THE DRAWINGS

The presently described embodiments exist in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the overall communication network including a mobile station, a base station, mobile switching center, a plurality of mobile gateways, an IP network and the public switch telephone network.

FIG. 2 is a more detailed illustration of the overall network as shown in FIG. 1.

FIG. 3 is a flow chart illustrating one embodiment of the method according to the present disclosure.

FIG. 4 is a flow chart illustrating another embodiment of the method according to the present disclosure.

### DETAILED DESCRIPTION

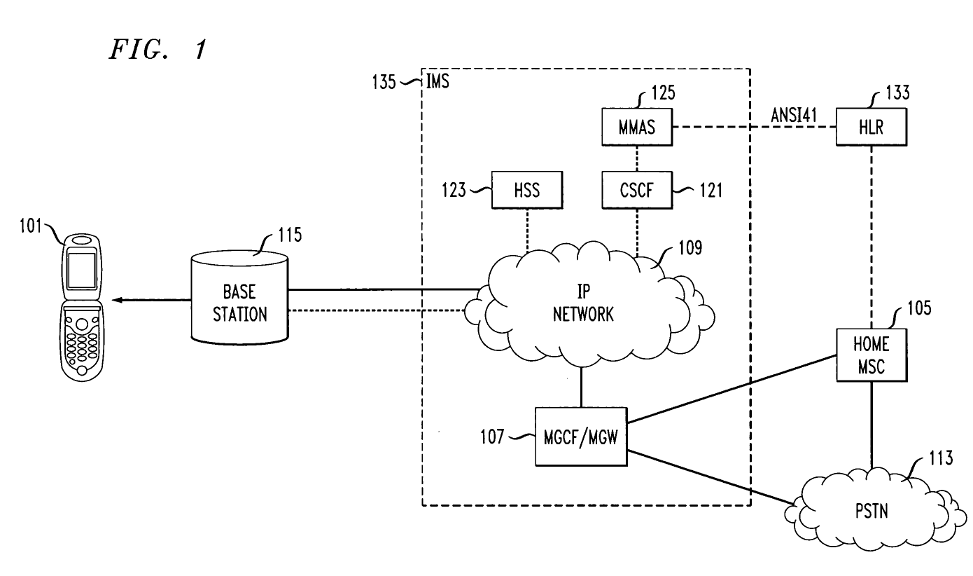

Referring now to the drawings wherein the showings are for purposes of illustrating the disclosed embodiments only and not for purposes of limiting the same. FIG. 1 provides an overall view of the system into which the present disclosure may be incorporated. A communications infrastructure A is shown. The communications infrastructure A includes a mobile station 101, a IMS network 135, a mobile switching center 105, a plurality of media gateways 107, 111, a base station 115, the IP network 109 and the Public Switched Telephone Network (PSTN) 113. It should be understood that this represents but one embodiment of the communications network infrastructure A. The present disclosure could be incorporated into a variety of communication network configurations.

In operation, as described in greater detail below, the presently described embodiments are directed towards a support architecture for CDMA 3G1x voice using IMS. In this sense, this disclosure describes a solution to the current problem which involves using a CDMA 3G1x voice through MSC core network, which uses a legacy circuit based solution. Because wireless service providers' further plans are to evolve their core network to IMS in order to support VoIP and other multimedia services over evolution data optimized (EV-DO) rev A, this is very convenient. Therefore, it is important to have one core network which supports both 3G1x voice and VoIP over EV-DO rev A. This will prevent wireless service provides from relying on two separate core networks, one with a legacy MSC and the other on IMS. By using a system such as the one disclosed capital investments in operational costs can be greatly decreased.

Still referring to FIG. 1, the system includes an associated CDMA 3G1x mobile station 101. As shown, it may be connected to a base station 115. The base station 115 in turn is being served by the IMS 135. The mobile switching center 105 is connected via intervendor trunk to the media gateway 107. The media gateway is in turn connected to the IP network 109.

As described in further detail below, this communication network may include other network elements, for example, switches, gateways, etc. These other communication networks may also include cellular networks, VoIP networks, the intranet, etc.

Continuing on with FIG. 1, this embodiment includes a mobile station 101 which is user equipment. However, other user equipment besides a mobile station shown may be substituted. Other examples of user equipment include, but are not limited to, wireless phones, VoIP telephones, laptop computers, desktop computers, Wi-FI phones, etc. These devices are typical user equipment used to communicate through compatible lines. In this embodiment, the mobile station is a CDMA 3G1x handset.

Through this disclosure, the call may be processed using the base station 115 in order to bypass the MSC 105 and the other network components. In this sense, after a call that is established within service range of the base station 115, the base station 115 may handle the call. The base station 115 may convert the call from the first network (a CDMA network, shown in FIG. as Network A) to the IP network 109 and the call will be served by IMS 145, and then forward the converted call through the IP network 109 to the media gateway 107 and through the PSTN 113. This would eliminate the need for the legacy circuit based MSC network.

The signal is divided into two portions, that bearer portion and the signaling portion. The base station 115 is used in order to convert both parts of this signal. The signal is converted in order to be processed by a SIP based system, in this embodiment the IMS 135. On the bearer path Enhanced Variable Rate Codec/Radio Link Protocol (EVRC/RLP) is converted into EVRC/Reliable Transport Protocol (RTP) in BTS 115. RLP is generally used for communication between a mobile station and a base station and RTP is used in multimedia real time traffic transportation. For the signaling portion the BST 115 is converting interoperability specification (IOS) to SIP.

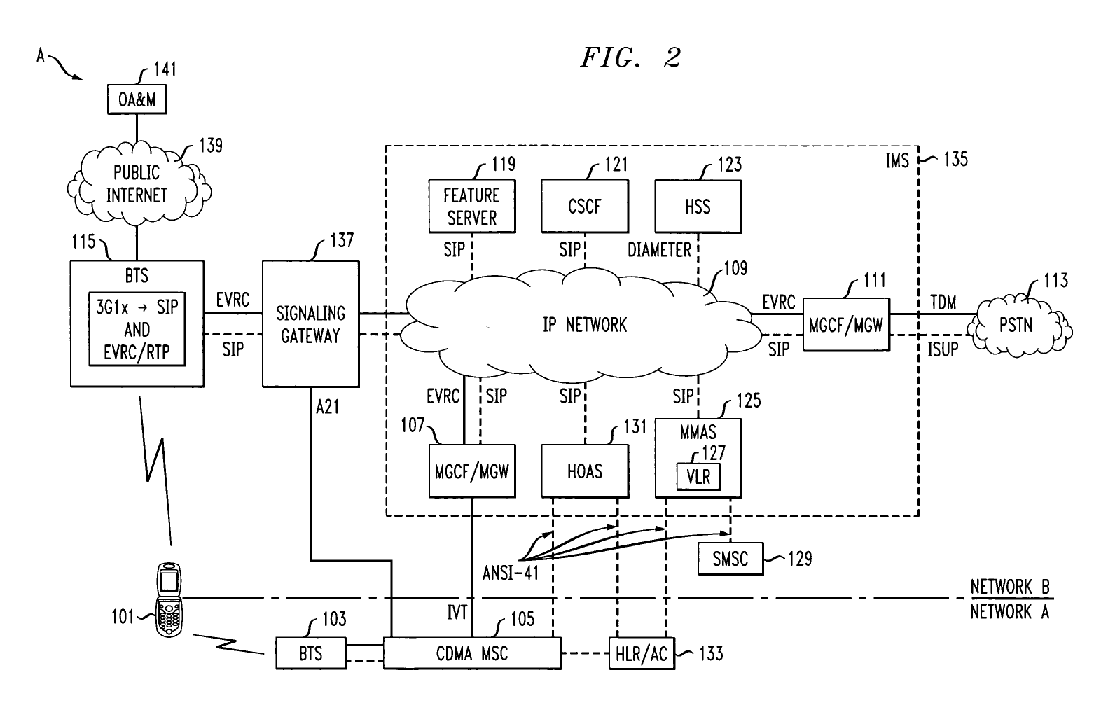

Now referring to FIG. 2 which shows a more detailed display of the overall network. FIG. 2 shows the elements of the two networks, network A and network B. Included in network A is a base station transceiver subsystem 103. The base station transceiver subsystem is 103 connected to the mobile switching center 105 which was also not shown in FIG. 1. The final shown element of network A is the Home Location Register and Authentication Center (HLR/AC) 133. These elements are interconnected through the ANSI-41 standards technology. This standard is well known in the art.

Still referring to FIG. 2, network B is also shown. Network B does not have an actual MSC. Instead, the IMS 135 is acted as serving MSC in order for the mobile unit 101 to communicate without creating a change in the overall function of the mobile unit 101 or the telecommunications network.

Network B includes the base station 115, which was shown in FIG. 1, which is in communication with an Signaling Gateway 137. The Signaling Gateway 137 is in communication with the IP network which has a variety of network elements which make up the IMS. These network elements include a feature server 119, a Call Session Control Function (CSCF) 121, a Home Subscriber Server (HSS) 123, a Mobility Application Service (MMAS) 125 which includes a Visitor Location Register (VLR) 127 and a Handoff Application Server (HOAS) 131. Also included in network B is a Short Message Service Center (SMSC) 129. It should be noted that the elements in network A and network B are but one embodiment of this disclosure. These network elements may be configured in a number of ways and still fall within the spirit and scope of the claims.

Still referring to FIG. 2, the disclosed method would eliminate the need for Network A as shown. Through this disclosure, the mobile station 101 would register with Network B through the base station 115. The signal then would continue through the Signaling Gateway 137 and travel to the IP Network 109 for processing. The base station 115 in this embodiment would include real time transport protocol in which the signal would be transformed and communicated via SIP messaging. In this form there would be no use for ANSI-41 standard protocol. Signal would be converted from 3G1x at the base station 115. In some embodiments the base station 115 is a femto base station. In another embodiment it is a macro base station. In any form, it is a base station that converts the signal making use of Network B without using Network A to process the call.

Continuing on, in this embodiment the variety of network elements perform various functions in processing the call. The Signaling Gateway 137 performs a third generation peer to peer (3GPP2) handoff for the CDMA mobile station 101.

The HLR 133 has the mobile station 101 feature and roaming information. The HLR 133 also contains the subscriber information for the handset. The subscriber information may include complimentary feature information. The HLR 133 may also include authentication information including an A key, etc.

The MSC 105 is also the home MSC for the mobile station 101 while in Network B. However, in Network B the IMS will act as the serving MSC for the mobile unit 101 while in Network B. In this sense, when the mobile station 101 roams into Network B the IMS will handle the mobile call. The mobile station 101 information will be transferred from the HLR 133 to another appropriate network element in order that the IMS can process the mobile call.

In this embodiment the MMAS 125 would hold the subscriber information at least temporarily while the call is handled in Network B. The VLR 127 may be used to store the subscriber information for the IMS.

Another network element in the IMS is the feature server 104. The feature server 1119 may be used to provide supplementary service to the mobile station 101. The supplementary service may include three way calling, call waiting, conference calling, call forwarding, etc.

The CSCF 121 may be used to provide session control for the mobile call. The CSCF 121 may be used to regulate bandwidth and maintain Quality of Service (QoS) throughout the call.

The HSS 123 also may be used to hold the handset subscriber information. In Network B this function was generally performed by the HLR 133. This information would be transferred to the HHS 123 when the mobile station 101 is operating in Network B. This information may include international mobile subscriber identity, the mobile identification number filter criteria, the electronic serial number, etc.

The SMSC 129 is used to interact with the MMAS 125 in order to provide short message services to the mobile station 101. The HOAS 131 may be used to handle hand-off procedures while the mobile station 101 is in Network B. The HOAS 131 may also be used in order to perform hand-off functions when traveling between Network A and Network B. This function may also be performed by the Signaling Gateway 135.

As the case with any of these functions, implementation of the various network elements depends on how the system is used. These functions may be performed by some or all of the network elements in conjunction or separate from another. This is but one embodiment of the proposed system and variations may exist.

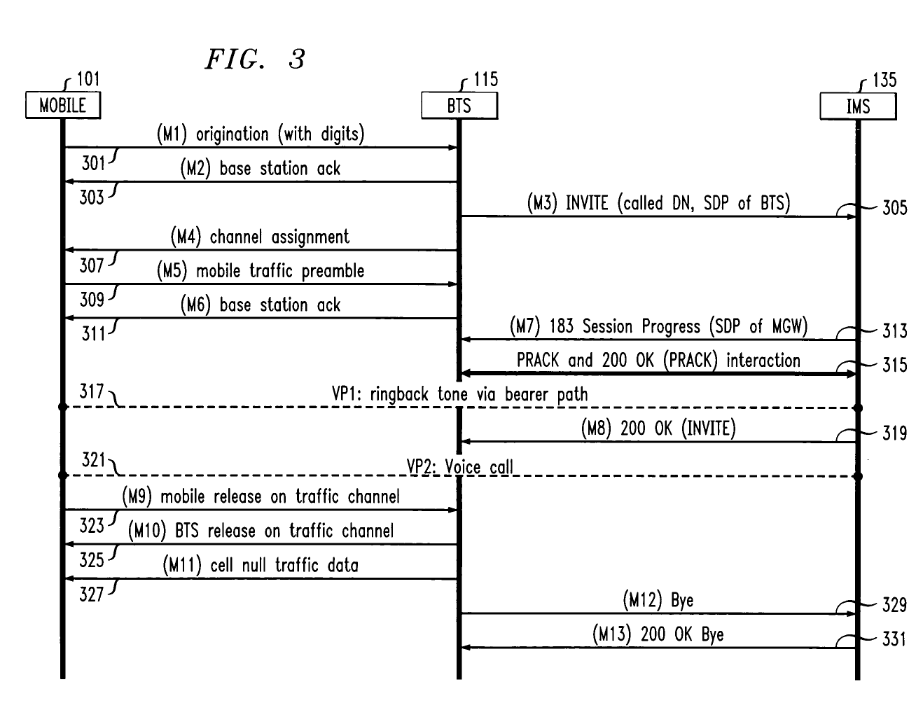

Now referring to FIG. 3 which is a flow chart illustrating one embodiment of the method according to the present disclosure. This embodiment is a 3G1x to SIP base station interworking. In this embodiment the base station 115 originates the call. This embodiment employs a base station mobile 101, a femtocell base station 115, and the IMS core which are shown in the overall communication networks in FIGS. 1 and 2. This method assumes that the mobile has been powered up and registration has been completed with the IMS core network. It should be understood that the method may be implemented by a variety of software and hardware configurations. It should also be understood that suitable software/hardware implementing the embodiments of the invention may also be distributed on any and/or all appropriate network elements.

The method begins with a mobile user dialing a phone number and pressing “send” on the mobile station 101. The first message 301 is the orientation with digits. This is a normal mobile origination, which is well known in the art.

Message 2 is the base station acknowledgement 303. This is also known in the art wherein the base station provides a normal CDMA radio response.

Message 3 is an invite message 305. The base station 115 translates the signal to a SIP invite. The method continues with Message 4, channel assignment 307. This is a known CDMA radio response that is provided by the base station 115. The method continues with a mobile traffic preamble 309 at Message 5 and continues with Message 6, a base station acknowledgment 311. These are CDMA radio responses which the base station has provided.

The method continues with Message 7, session progress 313. Provisional acknowledgement interaction is then established across the IMS core and the base station 115. This ignites a ring back tone via the bearer path 317.

The method continues with the called party answering the phone and the IMS core sending an invite message M8 at 319 which establishes the voice call between the mobile station 101 and the called party 321. The method continues after the conversation has ended the mobile release on the traffic channel M9 at 323. This will, in turn, clear up the resources associated with the call. M11 is the cell null traffic data at 327. This is provided by the base station and is a normal CDMA radio response. The base station 115 will then release the mobile 101 from the IMS network M12 at 329 and the call is released M13 at 331.

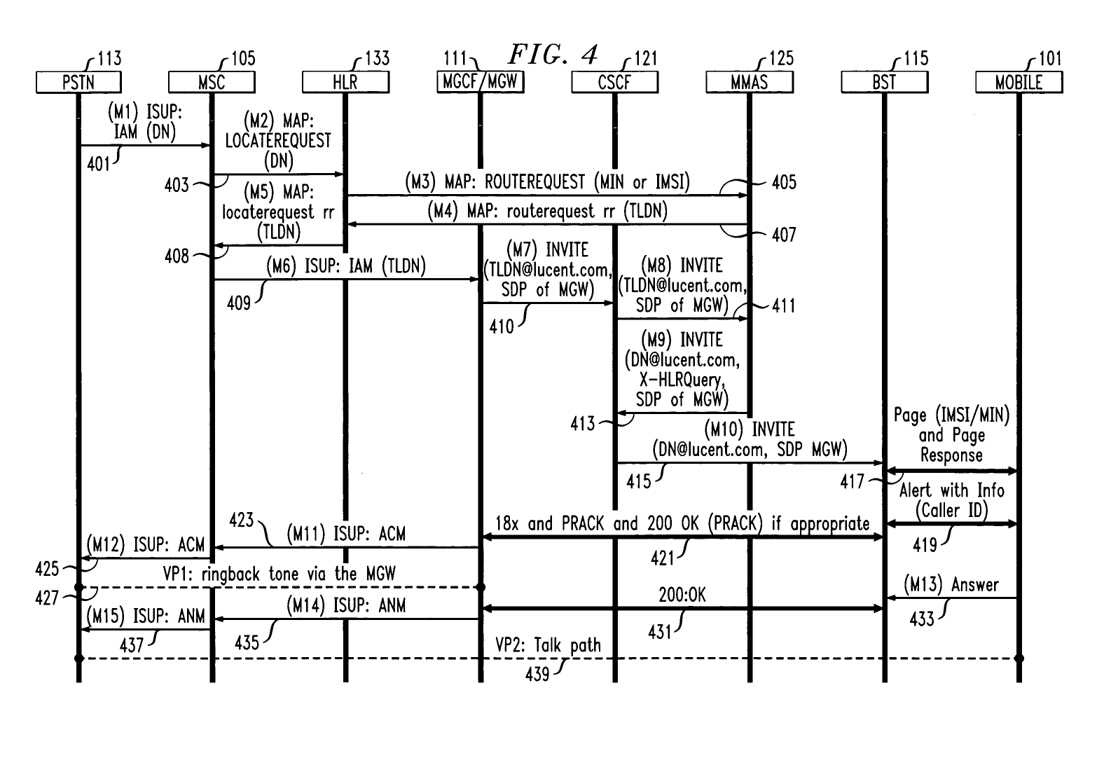

Now referring to FIG. 4, which is a mobile termination on the IMS and CDMA base station. This message also begins with the assumption that the MMAS 125 (FIG. 2) has registered as the serving system for the base station 115.

Ml is an incoming call to the home MSC at 401. The home MSC then sends a locator request at 403 in order to locate the called number. This request sent to the HLR which, once the phone has registered, is aware of the location of the mobile unit linked to the number dialed.

M3 is the querying of the registered serving MSC for a temporary routing number at 405. In this embodiment, the serving MSC is the IMS. Next, the IMS responds with the temporary routing number as message 4 at 407.

The HLR 133 then uses the temporary routing number and responds to the home MSC. Next, the home MSC routes the incoming call to the serving MSC via the temporary routing number. The media gateway 107 will then invite the called party through a SIP message at M7 409. Based on the temporary routing number, the invite is routed to the appropriate application server 125 (FIGS. 1 and 2) at 411.

The application server 125 retrieves the VLR 127 associated with that temporary routing number at step 413 M9. The application server 125 then reroutes the incoming call to the called mobile based on the temporary routing number. The call is then routed to the base station 115 serving this user. At step 415 a page is then sent from the base station 115 to the mobile station 101 via the mobile identification number or international mobile station identification. The page in turn is then responded to at 417. At 419, the alert with info is sent to the mobile 101. This would include any caller identification information that was linked with the call. At step 421, a provisional acknowledgement is sent and a response is sent if appropriate.

Message 11, the base station 115 pages for the user and at message 12. The base station 115 alerts the user including the calling party identification. This in turn brings a ring back tone via the media gateway 110 at step 427. The user then answers the call and an answer message is sent at step 433 in message 13. A 200 OK acknowledgment is then sent from the base station to the media gateway 112 which then sends an answer message to the home MSC which sends it to the PSTN 110 in messages 14 and 15 through steps 435 and 437. Finally, a talk path is established at step 439.

The above description merely provides a disclosure of particular embodiments of the claimed invention and is not intended for the purposes of limiting the same thereto. As such, this disclosure is not limited to only the above-described embodiments. Rather, it is recognized that one skilled in the art could conceive alternative embodiments that fall within the scope of the invention.

We claim:

1. A core network architecture for supporting an internet protocol based network comprising:
a base station configured to convert a signal from a first network signal to an internet protocol network signal and send said converted signal via said internet protocol based network;
a network gateway configured to receive said converted signal and deploy said converted signal though said internet protocol based network, where said internet protocol based network manages the call mobility and delivery of said signal.

2. The core network architecture according to claim 1, wherein said base station is a femtocell base station.

3. The core network architecture according to claim 1, wherein said first network is a code division multi access network.

4. The core network architecture according to claim 1, further comprising an OA&M configured to initialize relevant data associated with said converted signal.

5. The core network architecture according to claim 4 wherein said relevant data includes power settings.

6. The core network architecture according to claim 4 wherein relevant data includes a pseudo random number offset.

7. The core network architecture according to claim 4 relevant data includes a neighborhood list.

8. The core network architecture according to claim 1 further comprising a feature server configured to provide supplementary services associated with said converted signal.

9. The core network architecture according to claim 1 further comprising an mobile switching center emulator configured to facilitate with authenticating said mobile unit.

10. The core network architecture according to claim 1 further comprising a call session control function configured to provide mobile control for said signal.

11. A method for connecting a call for a code division multi access network based mobile on an internet protocol based network comprising:
registering a code division multi access mobile station on a internet protocol based network system employing a base station that is configured to convert a signal from said CDMA mobile station network signal to a session initiation protocol signal;
connecting a call between an end user and said code division multi access mobile unit though said internet protocol based network; and
processing said call through said internet protocol based system.

12. The method according to claim 10 wherein the call was originated from said code division multi access mobile station.

13. The method according to claim 10 wherein said call was terminated on said code division multi access mobile station.

14. The method according to claim 13 further comprising querying a serving mobile switching center for a temporary routing number.

15. The method according to claim 14 further comprising routing the call based on the temporary routing number.

16. A system for supporting voice and data in a wireless radio broadband data standard in an associated internet protocol multimedia system comprising:
a base station configured to translate a call that originates from a cell division multi access system into Session Initiation Protocol messaging;
a handoff application server configured to facilitate handoff procedures for said call;
a feature server configured to provide service features for said call; and
a network gateway that provides security between said base station and an associated core network and forwards said call through the associated internet protocol multimedia system.

17. The system according to claim 16, wherein said call originated in a code division multi access network.

18. The system according to claim 16, wherein said call is originated in a code division multi access mobile.

19. The system according to claim 16, wherein said base station is a femtocell base station.

20. The system according to claim 16 further comprising a mobility application severer which provides call management services for said call.
